(19) United States
(12) Patent Application Publication
(10) Pub. No.: US 2026/0072486 A1
(43) Pub. Date: Mar. 12, 2026

(54) POWER DISTRIBUTION SYSTEM FOR DATA CENTRE

(71) Applicant: Siemens Energy AS, Oslo (NO)

(72) Inventors: Alf Olav Valen, Jakobsli (NO); Simone Bertolucci, Oslo (NO); Saverio Struksnaes Ventrelli, Oslo (NO)

(21) Appl. No.: 19/105,903

(22) PCT Filed: Aug. 18, 2023
(86) PCT No.: PCT/EP2023/072814

§ 371 Date: Feb. 24, 2025

(30) Foreign Application Priority Data
Sep. 5, 2022 (GB) 2212914.2
Sep. 14, 2022 (GB) 2213471.2

(51) Int. Cl. G06F 1/26; H02J 4/00; H02J 7/00; H02J 15/00

(52) U.S. Cl. CPC G06F 1/26; H02J 4/00; H02J 7/855; H02J 15/30

(57) ABSTRACT

A data center electrical energy distribution system includes multiple AC, MV DC, and LV DC bus sections. A primary AC source connects to at least one AC bus section, while a secondary AC source connects to either an AC bus section or an MV DC bus section. Each MV DC bus section is linked to a DC source. The AC and LV DC bus sections operate as isolated islands, only connecting through MV DC bus sections. MV DC bus sections form a ring bus, interconnected via semiconductor switching units, which remain closed during normal operation.

### BACKGROUND

The present disclosure relates to a direct current (DC) power distribution system, or DC Grid, in particular for providing power to a data centre and to a method of operating such a system.

Conventionally, power distribution for data centres has been based on AC systems, which are relatively inefficient because of the multiple transformer and converter components between the sources and loads. Some proposals have been made to use DC distribution from an alternating current (AC) supply, but further improvements are desired.

### SUMMARY

In accordance with a first aspect of the present invention, a data centre electrical energy distribution system comprises a plurality of AC bus sections; a plurality of MV DC bus sections; and a plurality of LV DC bus sections; wherein a primary AC source is coupled to at least one of the AC bus sections; wherein a secondary AC source is coupled to at least one of the AC bus sections or to at least one MV DC bus section; wherein at least one DC source is coupled to each MV DC bus section; wherein each AC bus section and each LV DC bus section is an island having, respectively, no connection to another AC bus section at the same voltage level and no connection to another LV DC bus section at the same voltage level, other than through the MV DC bus sections; and wherein each MV DC bus section is connected to a neighbouring MV DC bus section to form an MV DC ring bus, the connection being through semiconductor switching units between the neighbouring MV DC bus sections, switches of the semiconductor switching units being closed in normal operation.

The plurality of AC bus sections, the plurality of MV DC bus sections and the plurality of LV DC bus sections may comprise three or four sections of each type.

Although the invention is applicable to a system having two bus sections of each type, more typically, there will be multiple bus sections of each type, such as three or four. There do not need to be the same number of bus sections for AC, MV DC and LV DC and the multiple sections of the MV DC bus are connected in a ring configuration, in normal operation. If an additional intermediate MV DC bus is provided, that may be connected in a ring configuration, or be arranged as islands.

Each section of the MV DC bus may be coupled to one or more energy storage units. Although a multi-section MV DC bus could operate with some sections not having energy storage units directly connected, the most efficient and most suitable arrangement in terms of redundancy, is to have one or more energy storage units coupled to each MV DC bus section.

The energy storage units may comprise at least one of battery energy storage, capacitors, supercapacitors, or flywheel energy storage.

The system may comprise at least two AC bus sections, at least three MV DC bus sections and at least two LV DC bus sections.

The primary AC source may comprise a utility supply, or an AC generator, in particular a gas turbine.

The alternative AC source may comprise one of a gas turbine, or a wind turbine.

The DC source may comprise a hydrogen fuel cell.

### BRIEF DESCRIPTION OF THE DRAWINGS

An example of a DC grid for power distribution according to the present invention will now be described with reference to the accompanying drawings in which:

FIG. 1 illustrates a first example of a DC power distribution system according to the present invention;

FIG. 2 illustrates a second example of a DC power distribution system according to the present invention; and,

FIG. 3 illustrates detail of a modifications to the DC power distribution system of FIGS. 1 and 2.

### DETAILED DESCIPTION

Conventional alternating current (AC) distribution systems, which have until recently been the standard distribution system for data centres, have poor efficiency due to the need for multiple transformers and converters between the power sources and the data centre loads. A consequence of the high-power demand of data centres is that the energy losses in the AC electrical distribution system are transformed into high costs for the electricity supply.

Another issue with conventional AC power distribution systems for data centres is that these typically do not allow the integration of renewable energy, but simply rely on utility power from conventional carbon power plants, with gas turbines or diesel engines provided for backup power. These conventional AC systems cannot meet the growing demand for data centres to use green energy and move towards carbon free operation.

Data centres have strict reliability requirements which have until recently been met by adding a large uninterruptable power supply (UPS) system to the conventional AC distribution system. The UPS system adds a significant capital cost to the complete data centre system, as well as adding to the operational costs, as the UPS must be maintained ready at any time to be brought into operation.

Data centres are often built in the proximity of large cities, where the cost for the construction land is high. The large number of UPS units, in addition to the basic data centre equipment, requires a lot of space, which must be purchased at a high cost, making the overall footprint a significant design consideration.

U.S. Pat. No. 10,013,037 describes providing primary AC power from utility supplies, or from generator sets, with a backup power supply to a data centre using a plurality of generator sets to supply either direct DC power from DC generators, or DC power that has been converted from AC generated in the generator sets. The supply to the servers or racks may be as AC or DC, with suitable conversion at the load. Moving from primary to back-up supply may be done quickly enough to reduce the size of temporary, e.g. battery, power.

U.S. Pat. No. 7,492,057 describes a high voltage DC power distribution system which converts utility or generator supplied three phase AC to high voltage DC, with rectifiers at the front end power source, rather than per component, so reducing the need for high cost components of AC systems, such as static switches and also reducing the heat generated during operation of the servers that are the loads in the power distribution system.

W02014026840 describes power distribution to a data centre which transforms medium voltage (MV) AC power provided on a utility line to a low or medium DC voltage provided on a first DC bus to feed DC loads on the DC bus.

US20110006607 describes a hybrid power supply apparatus for a data centre which uses an uninterruptible rack level power supply unit supplied with AC power from one or more power sources to supply DC power to a rack.

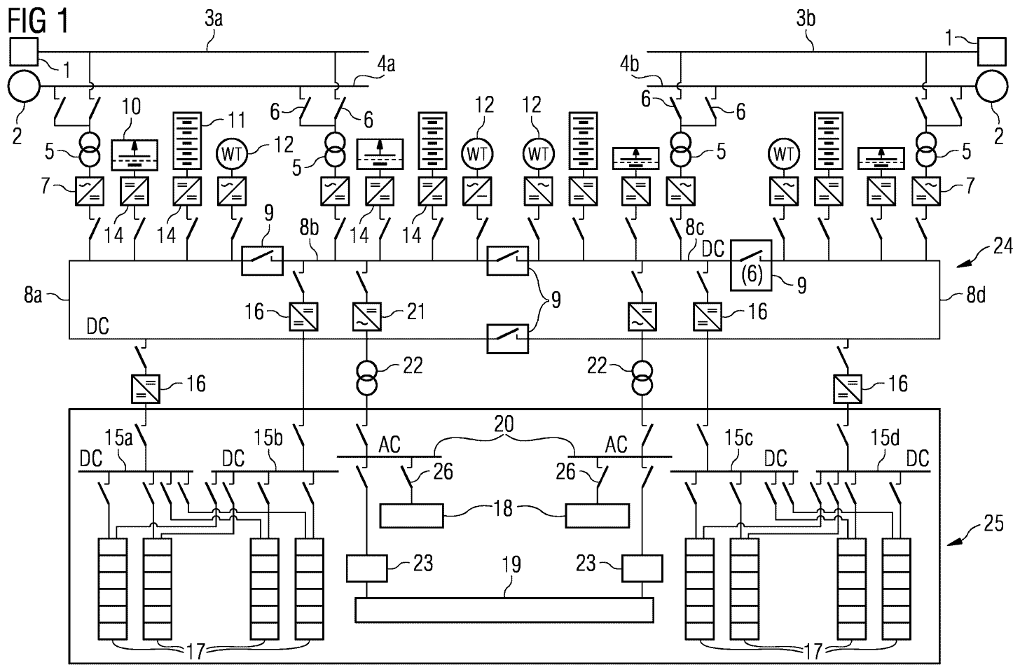

As indicated above, these systems convert from AC power supplies to DC, to directly supply the DC loads of the data centres, so reducing the losses in the system, using either UPS or redundancy from additional power sources. The present disclosure provides a way to use a DC distribution system, or DC grid, for powering up data centres, so that different energy sources and different energy storage devices can be integrated. An example of a DC grid according to the invention is described in FIG. 1 below. The example illustrates an MV DC ring configuration.

The main supply to the DC power distribution system of FIG. 1 may be from any type of main AC source, such as a utility grid 1, or alternative AC source 2, such as a gas turbine, or wind turbine, feeding into main AC bus 3a, 3b or alternative AC bus 4a, 4b respectively. The distribution system is arranged in this example to have two independent sets of main and alternative AC buses 3 a, 3b, 4a, 4b with no direct connection between these buses. This means that in the event of a fault on one of the buses e.g., 3a, that bus can be isolated and the non-faulty buses 3b, 4a, 4b can continue to operate. No loads are directly connected to the AC buses either. The AC buses simply serve to channel the supply which must be transformed down to a suitable operating voltage level in transformers 5. The transformers are coupled to the AC buses via galvanic isolation switches 6.

The output of the transformer is fed into an AC/DC converter 7, for example an unregulated or regulated rectifier, for connection of the AC power sources 1, 2 to a section 8a, 8b, 8c, 8d of a common medium voltage (MV) and thence to a low voltage (LV) DC bus system 15a, 15b, 15c, 15d. Each section 8a, 8b, 8c, 8d of the MV DC bus is connected to its neighbour via an ultra-fast DC switch 9 for interconnection of the different DC bus sections. One example of such a switch is described in EP 2589148. The switch 9 has the capability to disconnect a failed or faulty DC section within microseconds from the other sections, in the event of a fault or failure, thereby maintaining an uninterrupted voltage on the rest of the DC bus. In normal operation, the switches 9 are closed and the DC bus sections 8a, 8b, 8c, 8d are connected in a DC ring configuration 24.

As well as being coupled to the output of the AC/DC rectifier 7, one or more of the DC bus sections are coupled through switches 6 and DC to DC converters, or choppers 14 to one or more DC power sources 10, 11 for example, including, but not limited to, battery energy storage, fuel cells, flywheels, photovoltaic, or capacitors. In this example, a fuel cell stack 10 and battery stack 11 are illustrated on each section, but more or fewer, both in number and in different type of DC power source, may be used in each section. Some sections may have no DC source installed, some sections may have one or more DC sources installed, but at any particular time, may not have all of those installed DC sources in operation, for example, if there is a fault. In other cases, there may be multiple DC sources on each section, all of which are operational at a particular time. In addition, renewable energy, such as a wind turbine 12 may be connected via an AC/DC converter 13 and switch 6 to one or more of the DC bus sections. The AC/DC converter 13 may be chosen to convert only from AC/DC and not DC/AC, if there is no requirement for the wind turbine 12 to be able to receive power back from the DC bus sections at any time.

From the MV DC bus, further DC/DC choppers 16 are provided for stepping down and controlling the DC voltage on the LV DC bus sections 15a, 15b, 15c, 15d within the data centre, so that server racks 17 are supplied at a desired voltage. Unlike the MV DC bus sections 8a, 8b, 8c, 8d, there are no switches between the LV DC bus sections. Redundant supply is provided through the MV DC ring bus 24 instead. In this example, each LV DC bus section 15a, 15b, 15c, 15d is fed from a different MV DC bus section, through the DC/DC choppers 16, but each LV DC bus section can actually receive power that has been supplied to any one of the MV DC ring bus sections, provided that the DC switches 9 are closed to form a ring. In some situations, the supply may be to all LV DC bus sections from the same MV DC bus section, or fewer than all of the MV DC bus sections, according to the level of redundancy needed to reduce the risk of critical power shortages. If one section 8c has been disconnected from the ring by opening the switches 9 at each end of that section, then the servers 17 can still receive power from any one of the other sections 8a, 8b, 8d that are still connected together. At the LV DC bus section level, each server rack is connected to two separate LV DC bus sections, which again provides redundancy, in case of a fault or failure anywhere along the most direct chain from the main or alternative AC sources to that server.

The data centre 25 also includes some critical loads 19, on a separate switchboard, which have priority access to power. Mechanical loads 18 which are viewed as non-critical may lose power in preference to the critical loads. The mechanical loads in this example are supplied with AC power through DC/AC converters 21 for converting DC voltage from the DC ring bus sections 8b, 8c into an AC voltage through transformers 22 for supplying power at an appropriate level to the AC auxiliary loads 18, such as fan motors, pump motors, lighting, heating, etc. To provide redundancy, there are two separate AC buses 20 with switches 26 connecting the AC buses 20 to the transformers 22, mechanical loads 18 and critical motor control centre (MCC) 23, through which the critical loads are connected to the AC buses 20.

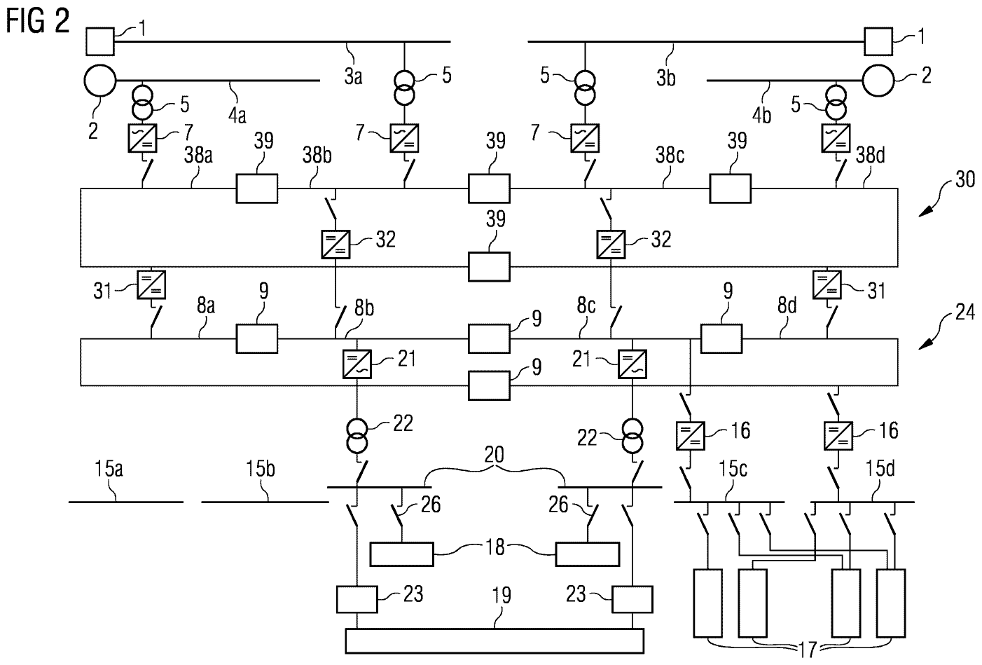

FIG. 2 shows detail of an alternative example of the DC grid of FIG. 1, having both an MV DC ring and an LV DC ring configuration. The same reference numerals are used as in FIG. 1 where the components perform the same function. By contrast with the example of FIG. 1, in this example, two DC closed rings are provided, at different DC voltage levels.

The first DC ring 30 is coupled to the AC buses via transformers 5; the second ring 24 is coupled to the first ring through DC to DC converters; the second DC ring 24 is coupled to the data centre servers 17 through DC/DC converters 16 and the second DC ring is coupled to the data centre auxiliary buses 20 through transformers 22. The various types of energy source or loads connected to the first DC ring 30 are omitted for clarity, but may include any of the multiple DC sources 10, 11, 12 described with respect to FIG. 1 and connected to DC buses 38a, 38b, 38c, 38d on the closed ring, in the same way as in the FIG. 1 examples.

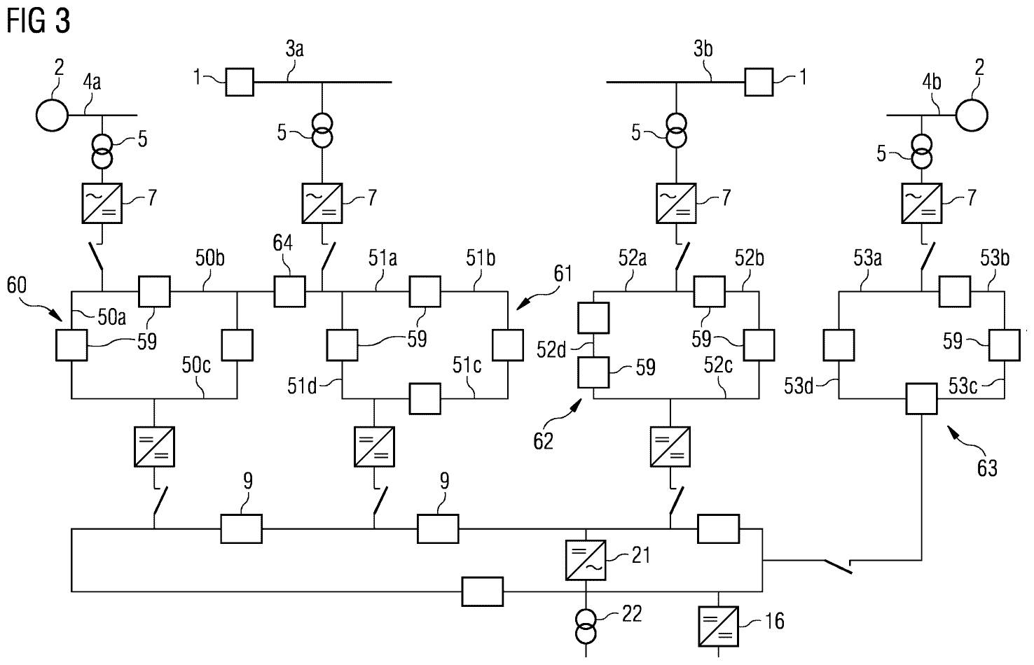

A third variant for the DC rings is illustrated in FIG. 3, with parallel or multiple DC ring options. On one side, the AC supply 1, 2 is coupled via transformers 5 and AC/DC converters 7 to two different closed rings 60, 61 in parallel, these two rings being able to be coupled together on that side via a fast breaker 64. The first ring 60 comprises bus sections 50a, 50b, 50c, connected together by three ultrafast DC switches 59. The second ring comprises bus sections 51a, 51b, 51c, 5 Id connected together by four switches 59. In the example shown, they supply to the second DC ring 24 through DC/DC transformers as previously described.

On the other side the AC supply 1, 2 is coupled via transformers 5 and AC/DC converters 7 to quite separate rings 62, 63, with no facility to couple those two rings together. Here, one ring 62 comprises bus sections 52a, 52b, 52c, 52d connected together in a ring via four switches 59 and the other ring 63 comprises bus sections 53a, 53b, 53c, 53d connected together in a ring through four switches 59. As before sections of each ring supply either DC, via DC/DC converters 16, to the data centre servers, or AC, via DC/AC converters 21 and a transformer 22, to the data centre auxiliary buses (omitted for clarity). As with the FIG. 2 example, the various types of energy source or loads connected to the first DC rings 60, 61, 62, 63 are omitted for clarity, but may include any of the multiple DC sources 10, 11, 12 described with respect to FIG. 1 and connected to DC buses on each closed ring, in the same way as in the FIG. 1 examples.

Although the figures show two rings on either side, the invention is not limited to this and where more appropriate for the physical layout of the site, there may be more than two rings on one side and/or only one ring on one side. The precise ring design, both in terms of number and location, depends upon the physical arrangement for the supply—over a large site, runs of copper cable for a single ring to connect to all AC and all DC sources may result in high losses and high costs. In such a situation, a larger number of rings, extending over a smaller physical run length are preferred.

Energy from an energy source is provided to sections 3a, 3b of the main AC bus from a utility grid 1 or energy is supplied from an alternative AC source 2, such as a gas turbine, to sections 4a, 4b of an alternative AC grid. The AC supply required for many loads is typically 230V ac single phase and 400V ac three phase at 50 Hz, for Europe, with deviations from these in both voltage and frequency in other countries, but still of the same order of magnitude, so the generated AC supply, originally at much higher levels, e. g HV AC, or MV AC, must be transformed down. The AC supply is transformed down 41 to a lower voltage, typically medium voltage AC, then converted to medium voltage DC. The actual voltages on any bus sections depend upon the specific application. For relatively small data centres, a power rating of about 1 MW may have an LV AC supply converting to about 930 V DC on the ring, or 690 V AC, for loads requiring a supply at about 24 V DC to 50V DC. For higher power rates, the MV AC supply may be anything up to 36 kV AC. Above this voltage, the system would be a high voltage (HV AC) system. For the DC ring, anything below 1500V DC is considered low voltage and above that, there is no formal distinction between MV DC and HV DC.

In addition to the power from the utility or alternative AC supply 1, 2, other AC sources, such as wind turbines, may be connected 42 to the DC bus through AC/DC converters to supply DC to the MV DC bus sections 8a, 8b, 8c, 8d. Direct DC supply to the MV DC ring bus may be provided 43 by DC sources such as fuel cells or batteries, through DC/DC converters. The batteries are able to store surplus energy received from the DC bus, or discharge energy to the DC bus for loads by downconverting 44 from MV DC to LV DC. Servers connected to the LV DC buses are supplied 45 from one of the buses, with the option to be supplied from another LV DC bus directly, or through the MV DC ring bus connections. Within the data centre, there are also AC loads connected to LV AC buses, which may be critical loads, or mechanical loads. These are supplied from the MV DC ring bus through DC/AC converters to the LV AC buses.

The example of FIG. 1 assumes a relatively close relationship between the AC sources, the DC ring voltage and the load voltages. However, for higher power demand, there may be an additional bus system at MV, for example at 6.6 kV DC, which is converted down to LV DC, e.g. at 930 V DC, or 1 kV DC and then to the LV DC load voltage at, for example, 24V DC. In addition to the MV DC ring bus 24 at 930V DC, an intermediate MV DC bus 30 at 6.6 kV DC is provided. The bus is illustrated with four intermediate MV DC bus sections 38a, 38b, 38c, 38d which receive DC transformed down from the AC source supply, by transformers 5 and converted to DC in AC/DC converters 7. Additional DC/DC converters 31, 32 are provided between the intermediate MV DC bus sections 38a, 38b, 38c, 38d of the intermediate MV ring bus 30 and the MV DC bus sections 8a, 8b, 8c, 8d of the MV ring bus 24, to convert the DC to a suitable voltage for the ring bus 24 and thereafter converted DC/AC 21 and transformed 22 to supply AC for those mechanical loads 18 and critical loads 19 requiring an AC supply, or down conversion DC/DC 16 for the data centre racks 17 on DC bus sections 15a, 15b, 15c, 15d.

Control of supplying energy from the different sources to the different loads arises by virtue of potential differences between the buses and the loads. When there is an excess of energy on any of the LV DC bus sections, the loads may draw current and the consequential change in balance of potential causes energy storage or other energy sources connected to the MV DC bus sections or to the AC bus sections to provide power to replace that taken from the LV DC bus sections by a consumer.

The racks of servers within the data centre always draw power and may be cooled by water cooling or air cooling to remove the heat generated during operation. The operational voltage is typically of the order of 50V DC to the different racks and systems. There may be galvanic isolation between the server buses 15a, 15b, 15c, 15d and the DC/DC converters 16 from the low voltage ring 24, as this deals with earth faults. The LV ring 24 operates in the range of 50 to 1500 V DC, trading off the need to keep the current low (hence higher voltage) for efficiency and cost reasons, with the available voltage from the various voltage sources. Within the closed ring LV bus, different bus sections are connected via normally closed fast semiconductor switches which are rated to open sufficiently quickly in the event of a fault on one section to prevent propagation of the fault to other sections.

The battery systems 11 may be regulated using a DC/DC converter 14, which gives greater flexibility that using a direct connection of the batter to the LV DC bus. Similarly for the fuel cells 10, the DC/DC converter 14 allows more flexible regulation of the available power sources. Generators 12 in this set up tend to be small scale, for example diesel generators. For the AC/DC conversion, regulation may be provided, or fixed diodes used, but in the latter case, then voltage control at the generators is needed. Transformers 5 transform from the higher level AC at medium voltage, typically 6.6 kV to 130 kV from the local grid or gas turbines. Wind turbines may generate at 66 kV or 132 kV. For data centres, it is desirable to always have a redundant feed. As the AC voltage can vary, active regulation of some kind is needed, e.g. controllable semiconductor regulators in the AC/DC converters 7.

A power management system is then able to share the loads because of the controllable elements. Assuming that making full use of the fuel cell power, optimising the fuel cell output, is most efficient, as well as using power from DC generators, then any remaining demand can be met from the AC supply via transformers 7, with energy from the batteries on the LV closed ring providing peak shaving, top-up energy, or as a short term supply in the case of other system shutdowns. It is desirable that any particular section should have a mix of supply and load on it, although the redundancy connections mean that it is possible to supply across sections to loads on other sections, if needed. As explained above, this may be less efficient because of the losses in transmitting power over long cable runs. The connections to the LV DC ring also provide the data centre auxiliaries with a redundant supply, which has not been available in the past, where the auxiliaries were segregated at a higher level and supplied from the main AC supply.

The present invention provides parallel connection and control of different types of energy sources and different types of storage means, as well as multiple individual instances of the same type of energy source which share or seamlessly takeover the data center load without interruptions. This avoids the need to provide uninterruptable power supplies (UPS's), yet still maintains and enhances the reliability of the power supply to the datacenter. The main DC bus closed ring configuration provides redundant power supply with a reduced number of AC power sources and transformers, reducing costs but still guaranteeing maximum reliability and high efficiency. This is thanks to the ultra-fast DC circuit breaker, which can isolate faulty sections of the bus without interfering with the operation of the other connected bus sections. The ultra-fast DC breaker gives the required discrimination without making voltage interruptions. The overall losses compared with a conventional system are also reduced because reducing the number of components between the power sources and the loads at the data centres means there are fewer loses. In this way an efficiency improvement of up to or greater than 20% may be achieved.

Operating a data centre with a DC grid as described, enables energy from different renewable sources to be integrated, so that the system can be operated with a low to zero carbon footprint. Using the system as described, provides uninterrupted power supply and so eliminates the need for the traditional UPS units. These are particularly costly parts of the conventional system, so removing these has a significant impact on reducing the capital and operational costs of the data centres. Without the UPS, there is a corresponding reduction in the total footprint of the power distribution system and the overall data centre facility. Most UPS system incorporate batteries and as they are designed for use onshore, close to firefighting capacity, there is a higher risk of battery fires, than using a system that has been designed to meet the very high safety requirements of offshore vessels and rigs. The energy storage units in use in the present invention have been designed for a higher safety level. The ultrafast DC switch provides electrical protection of the overall system by allowing for safe disconnection of failure sections within a few microseconds. This leaves the remaining healthy sections operating in a safe and uninterrupted manner.

Embodiments of the invention have been described with reference to different subject matter. In particular, some embodiments have been described with reference to method type claims whereas other embodiments have been described with reference to apparatus type claims. However, a person skilled in the art will gather from the above and the following description that, unless otherwise notified, in addition to any combination of features belonging to one type of subject matter, any combination of features relating to different subject matter, in particular between features of the method type claims and features of the apparatus type claims is considered to be disclosed by this document too. It should be noted that the term “comprising” does not exclude other elements or steps and “a” or “an” does not exclude a plurality. Also, elements described in association with different embodiments may be combined. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. It should also be noted that reference signs in the claims should not be construed as limiting the scope of the claims. The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

1. A data centre electrical energy distribution system comprising:
a plurality of AC bus sections;
a plurality of MV DC bus sections; and
a plurality of LV DC bus sections; wherein a primary AC source is coupled to at least one of the AC bus sections,
wherein a secondary AC source is coupled to at least one of the AC bus sections or to at least one MV DC bus section; wherein at least one DC source is coupled to each MV DC bus section,
wherein each AC bus section and each LV DC bus section is an island having, respectively, no connection to another AC bus section at the same voltage level and no connection to another LV DC bus section at the same voltage level, other than through the MV DC bus sections, and
wherein each MV DC bus section is connected to a neighboring MV DC bus section to form an MV DC ring bus, the connection being through semiconductor switching units between the neighboring MV DC bus sections, switches of the semiconductor switching units being closed in normal operation.

2. A system according to claim 1, wherein the plurality of AC bus sections, the plurality of MV DC bus sections and the plurality of LV DC bus sections comprise three or four sections of each type.

3. A system according to claim 1, wherein each section of the MV DC bus is coupled to one or more energy storage units.

4. A system according to claim 3, wherein the one or more energy storage units comprise at least one of battery energy storage, capacitors, supercapacitors, or flywheel energy storage.

5. A system according to claim 1, wherein the system comprises at least two AC bus sections, at least three MV DC bus sections and at least two LV DC bus sections.

6. A system according to claim 1, wherein the primary AC source comprises a utility supply, or an AC generator, in particular a gas turbine.

7. A system according to claim 1, further comprising an alternative AC source, wherein the alternative AC source comprises one of a gas turbine, or a wind turbine.

8. A system according to claim 1, wherein the DC source comprises a hydrogen fuel cell.
